(19) United States
(12) Patent Application Publication
(10) Pub. No.: US 2016/0085844 A1
(43) Pub. Date: Mar. 24, 2016

(54) TAG ADDING APPARATUS AND TAG ADDING METHOD

(71) Applicant: KABUSHIKI KAISHA TOSHIBA, Tokyo (JP)

(72) Inventors: Masayuki Okamoto, Kawasaki Kanagawa (JP); Kosei Fume, Kawasaki Kanagawa (JP)

(21) Appl. No.: 14/848,014

(22) Filed: Sep. 8, 2015

(30) Foreign Application Priority Data
Sep. 18, 2014 (JP) 2014-190225

(51) Int. Cl. G06F 17/30

(52) U.S. Cl. CPC G06F 17/30598; G06F 17/30528; G06F 17/30345

(57) ABSTRACT

According to one embodiment, a tag adding apparatus includes the following units. The input unit inputs an input tag added to an input content item. The storage unit stores registered content items in association with registered tags. The search unit retrieves a first and a second content aggregate from the storage unit. The analyzer analyzes the number of content items of the first content aggregate, and to analyze an inclusion relationship between the first and the second content aggregate. The determination unit determines an additional tag to be additionally added to the input content item based on a result of analysis. The registration unit registers the input content item in the storage unit in association with the input tag and the additional tag.

### CROSS-REFERENCE TO RELATED APPLICATIONS

This application is based upon and claims the benefit of priority from Japanese Patent Application No. 2014-190225, filed Sep. 18, 2014, the entire contents of which are incorporated herein by reference.

### FIELD

Embodiments described herein relate generally to a tag adding apparatus and tag adding method.

### BACKGROUND

A function of adding a tag (also referred to as an annotation, notes, or the like) is provided to apparatuses or services dealing with electronic content as a way to classify/arrange electronic content such as web pages, electronic documents, electronic books, etc. With such an environment, the user can add a desired tag to the electronic content by using a text entered by the user, text entered by some other user, or mechanically determined text. The tag is utilized, for example, to search for content.

However, when the user adds a tag, not much consideration is given to ease of searching in many cases. As a method of retrieving content to which a tag is added, carrying out search refinement by selecting a tag, and carrying out full-text searching similar to general document searching are generally employed. When the tag added by the user is inappropriate, it is difficult to find out the objective content by search refinement. In such a case, the user eventually resorts to using full-text searching, and the added tag is not utilized. A technique for enhancing search potential while allowing the user to have the flexibility to personally add a tag to the content becomes necessary.

### BRIEF DESCRIPTION OF THE DRAWINGS

FIG. 1 is a block diagram showing a tag adding apparatus according to an embodiment.

FIG. 2A is a view showing an example of a failure in search refinement.

FIG. 2B is a view showing an example in which sufficient refinement cannot be carried out.

FIG. 3 is a flowchart showing tag registration processing to be carried out by the tag adding apparatus shown in FIG. 1.

FIG. 4 is a view showing an example of tag management in a storage unit shown in FIG. 1.

FIG. 5 is a view illustrating a difference in the tagging method corresponding to the user's interest.

FIG. 6 is a view showing part of registered content accumulated in the storage unit shown in FIG. 1.

FIG. 7 is a block diagram showing a content search apparatus according to an embodiment.

### DETAILED DESCRIPTION

According to one embodiment, a tag adding apparatus includes an input unit, a storage unit, a search unit, a search unit, an analyzer, a determination unit, and a registration unit. The input unit inputs an input tag added to an input content item. The storage unit stores registered content items in association with registered tags added to the registered content items. The search unit retrieves a first content aggregate and a second content aggregate from the storage unit, the first content aggregate being an aggregate of registered content items to which registered tags matching the input tag are added, the second content aggregate being an aggregate of registered content items to which registered tags matching an additional tag candidate are added. The analyzer analyzes the number of registered content items of the first content aggregate, and to analyze an inclusion relationship between the first content aggregate and the second content aggregate. The determination unit determines an additional tag to be additionally added to the input content item based on a result of analysis by the analyzer. The registration unit registers the input content item in the storage unit in association with the input tag and the additional tag.

Hereinafter, various embodiments will be described with reference to the drawings, In the following embodiments, identical elements are denoted by identical reference symbols, and duplicated descriptions are omitted.

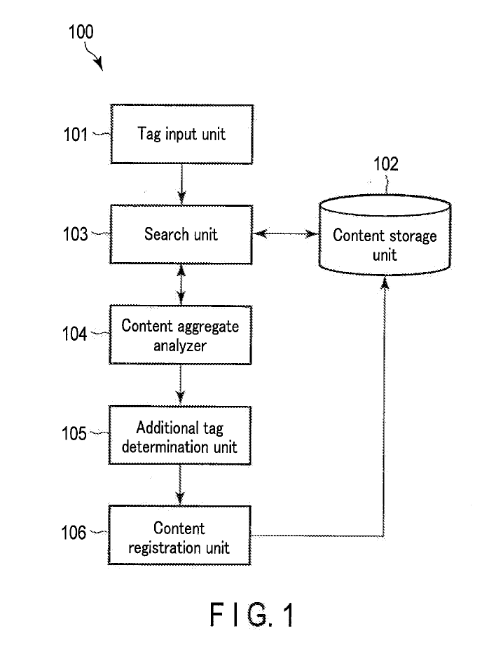

FIG. 1 schematically shows a tag adding apparatus 100 according to an embodiment. The tag adding apparatus 100 can be applied to a terminal to which a tag can be input, or an application or a service utilized on the terminal. The tag is also called an annotation, notes, or the like. Examples of terminals to which a tag can be input include a personal computer (PC), smartphone, tablet terminal, electronic book reader, game machine, etc.

The tag adding apparatus 100 determines an additional tag, which is a tag to be additionally added to the electronic content, based on an input tag that is a tag added to the electronic content by the user, and preserves the electronic content in association with the input tag and the additional tag. The additional tag makes it easy for the user to retrieve desired content, i.e., the additional tag enhances search potential. Examples of the electronic content include web pages, electronic documents, TV or other programs, still images, moving images, etc. A tag adding operation is included in the function of classifying/arranging the electronic content such as a storage function of the electronic content, bookmarking function, etc. Such functions are provided to devices or services dealing with electronic content. In the following descriptions, electronic content will simply be called content.

As shown in FIG. 1, the tag adding apparatus 100 includes a tag input unit 101, content storage unit 102, search unit 103, content aggregate analyzer 104, additional tag determination unit 105, and content registration unit 106. The tag input unit 101, search unit 103, content aggregate analyzer 104, additional tag determination unit 105, and content registration unit 106 can be realized by a central processing unit (CPU), and memory used by the CPU. The content storage unit 102 can be realized by the memory or an auxiliary storage device used by the CPU.

The tag input unit 101 receives an input tag added to the content item. In the following, a content item to which an input tag is added by the user is called an input content item. The input tag is designated by the user when the content item is stored in the content storage unit 102. In an example, the user directly inputs text by using a keyboard or a software keyboard. In another example, the user designates an input tag by speaking. In this case, the speech of the user is converted into text by a speech-recognition technique. In still another example, the user designates an input tag by handwritten character input using a touch panel. In this case, the handwritten characters of the user are converted into text by a character recognition technique. In still another example, the user selects one of tag candidates recommended and presented by an application.

The content storage unit 102 stores therein the content items in association with the tags added to the content items. In the following, the content item stored in the content storage unit 102 is called the registered content item, and the tag added to the registered content item is called the registered tag.

The search unit 103 retrieves from the content storage unit 102 a plurality of content aggregates including a first content aggregate and second content aggregate, based on the input tag. The first content aggregate is an aggregate of registered content items to which registered tags matching (i.e., coincident with or similar to) the input tag are added. The search unit 103 searches the content storage unit 102 by using the input tag as a search query to thereby acquire the first content aggregate. As the search query, an additional tag candidate to be set based on a result of an analysis of the first content aggregate carried out by the content aggregate analyzer 104 can also be used in addition to the input tag. The search unit 103 searches the content storage unit 102 by using an additional tag candidate as a search query to thereby acquire an aggregate of registered content items to which registered tags matching the additional tag candidate are added as a second content aggregate. When there is a plurality of additional tag candidates, a second content aggregate is created for each of the additional tag candidates.

The content aggregate analyzer 104 analyzes a plurality of content aggregates retrieved by the search unit 103. Specifically, the content aggregate analyzer 104 analyzes the number of content items of the first content aggregate, and an inclusion relationship between the first content aggregate and second content aggregate.

The additional tag determination unit 105 determines an additional tag to be additionally added to the input content item on the basis of a result of the analysis carried out by the content aggregate analyzer 104. The content registration unit 106 registers the input content item in the content storage unit 102 in association with the input tag and additional tag.

As described above, the content item is preserved in the content storage unit 102 together with the tag (input tag) added by the user, and a tag (additional tag) recommended by the tag adding apparatus 100. In general, the user does not always add a tag to the content item after taking the ease of searching into consideration. Accordingly, when only a tag added by the user is simply added to the content item, a problem exemplified in the following is caused at the time of searching in some cases.

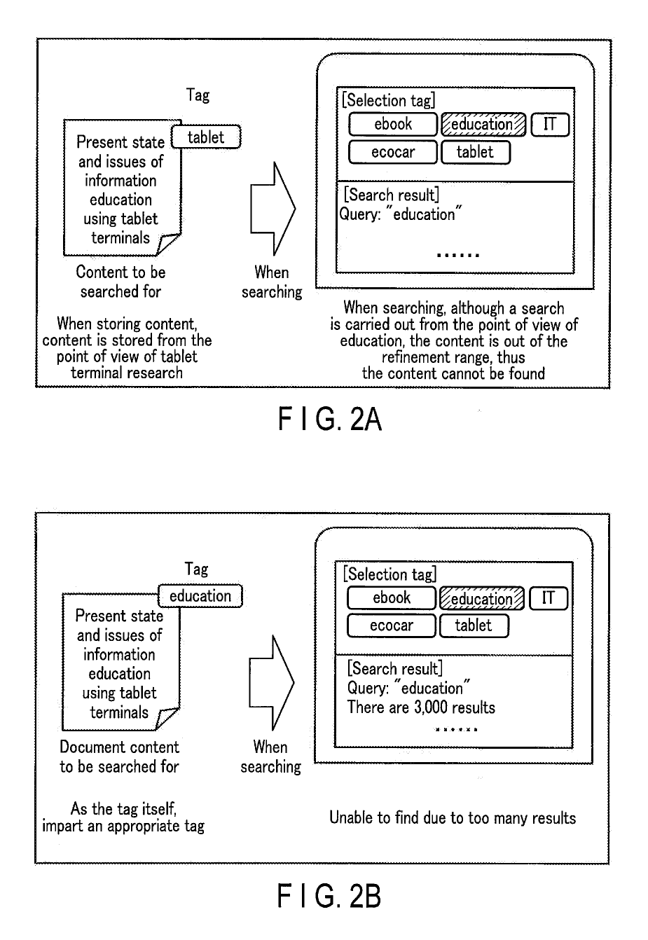

FIG. 2A shows an example of a failure in search refinement. As shown in FIG. 2A, it is assumed that when storing the content item associated with “Present state and issues of information education using tablet terminals”, the user adds a tag “tablet” from the point of view of the topic of the tablet. Later, the user is obliged to study the topic of education, and tries to search for this content item. At this time, in order to search for the content item associated with education, the user carries out search refinement by using a tag “education”. However, this content item is out of the refinement range, so the user cannot find the content item.

FIG. 2B shows an example in which sufficient refinement cannot be carried out. As shown in FIG. 2B, it is assumed that when storing the content item associated with “Present state and issues of information education using tablet terminals”, the user adds a tag “education” from the point of view of the topic of education. Later, in order to search for this content item, the user carries out search refinement by using the tag “education”. However, a large number of content items are presented to the user as a result of the search, and refinement cannot be carried out to such an extent that the content item can easily be found.

When falling into such situations, the user eventually uses, for example, full-text searching, and the added tag is not utilized. The tag adding apparatus 100 according to this embodiment adds an additional tag in order to enhance the search potential while allowing the user to have the flexibility to personally add a tag.

Next, an operation of the tag adding apparatus 100 will be described below.

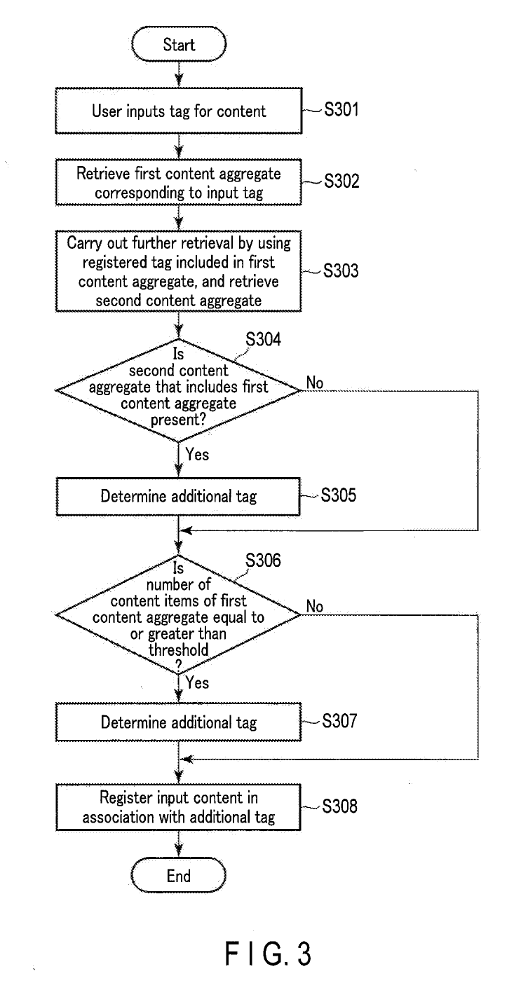

FIG. 3 schematically shows content registration processing to be executed by the tag adding apparatus 100. In step S301 of FIG. 3, the tag input unit 101 receives an input tag added to the input content item by the user. In step S302, the search unit 103 retrieves registered content items to each of which a registered tag matching the input tag is added from the content storage unit 102, and outputs these retrieved registered content items as a first content aggregate.

In step S303, at least one of registered tags added to the registered content items in the first content aggregate is set to an additional tag candidate, and further searching is carried out by using the additional tag candidate. An aggregate of registered content items acquired for each additional tag candidate is output as a second content aggregate. Specifically, the content aggregate analyzer 104 creates one or more sub-aggregates from the first content aggregate. In an example of a method of creating a sub-aggregate, a registered tag contributory to (i.e., useful for) search refinement of the input content item in the first content aggregate is selected from registered tags added to the registered content items in the first content aggregate, and an aggregate of the registered content items to each of which the selected registered tag is added is set to a sub-aggregate. As the evaluation criterion, criteria utilized in the decision tree construction such as ID3, C4.5, and the like can be used. The registered tag forming the sub-aggregate is set to an additional tag candidate. It should be noted that a word in the input content item may be set to the additional tag candidate.

In step S304, the content aggregate analyzer 104 determines whether or not a second content aggregate including the first content aggregate is present. In the one embodiment, that the second content aggregate includes the first content aggregate indicates that the whole first content aggregate is included in the second content aggregate. In another embodiment, this condition may be relaxed. That is, that the second content aggregate includes the first content aggregate can indicate that a ratio of the registered content items included in both the first content aggregate and second content aggregate to all of the registered content items in the first content aggregate is equal to or greater than a threshold. When a second content aggregate including the first content aggregate is present, processing advances to step S305 and, when a second content aggregate including the first content aggregate is not present, the processing advances to step S306

In step S305, the additional tag determination unit 105 determines a registered tag forming the second content aggregate including the first content aggregate as an additional tag. The additional tag determined in step S305 corresponds to superordinate conception of the input tag.

In step S306, the content aggregate analyzer 104 determines whether or not the number of content items of the first content aggregate is equal to or greater than a threshold. This threshold may be a constant determined in advance, and may be changeable by, for example, adjusting according to the number of registered content items stored in the content storage unit 102. When the number of the content items of the first content aggregate is equal to or greater than the threshold, the processing advances to step S307 and, when the number of the elements of the first content aggregate is smaller than the threshold, the processing advances to step S308.

In step S307, the additional tag determination unit 105 determines at least one of registered tags added to the registered content items in the first content aggregate, and contributory to search refinement of the input content item in the first content aggregate as an additional tag. Specifically, the additional tag determination unit 105 determines a registered tag forming sub-aggregate which is among the sub-aggregates and to which the input content item conforms as an additional tag. Alternatively, a registered tag which is high in the Inverse Document Frequency (IDF) may be selected from among registered tags added to the registered content items in the first content aggregate as an additional tag. Thereby, it becomes even easier to refine the input content in the sub-aggregate. Alternatively, the additional tag determination unit 105 may determine, as an additional tag, a word in the input content item which is contributory to search refinement of the input content item in the first content aggregate. The additional tag determined in step S307 corresponds to subordinate conception of the input tag.

In step S308, the content registration unit 106 registers the input content item in the content storage unit 102 in association with the input tag and the additional tag determined by the additional tag determination unit 105.

In this way, the tag adding apparatus 100 according to this embodiment determines an additional tag based on the input tag designated by the user, and registers the input content item in associated with the input tag and the determined additional tag. Therefore, it is possible to carry out tag supplementation in consideration of the intention of the user.

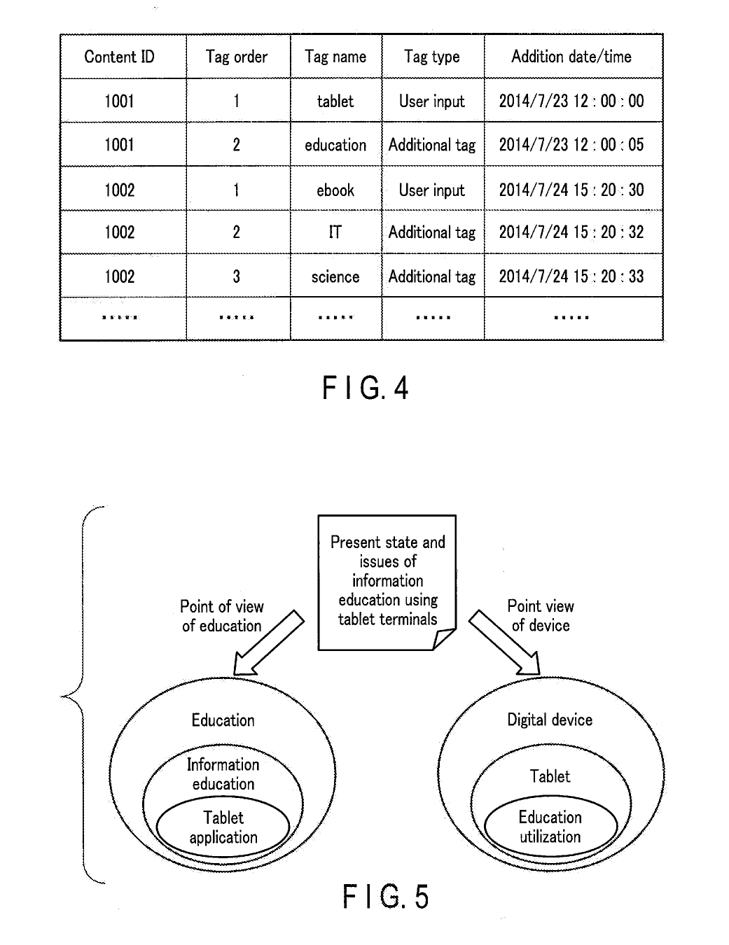

FIG. 4 shows an example of tag management in the content storage unit 102. The table shown in FIG. 4 includes fields of content ID, tag order, tag name, tag type, and addition date/time. The content ID is information used to identify a registered content item. In FIG. 4, information about the registered content item itself is omitted. The tag order is information utilized, for example, when the display priority order or the like is added to the tag. The tag name indicates a name (character string) of a tag. The tag type indicates a type of a tag such as “user input”, “additional tag” or the like. Here, “user input” indicates that the corresponding tag name has been added to the tag by the user, and “additional tag” indicates that the corresponding tag name has been added thereto by the tag adding apparatus 100. The addition date/time indicates the date/time of when the tag name has been added to the tag. For example, with the registered content item having the content ID of 1002, one input tag, and two additional tags are associated.

FIG. 5 exemplifies a difference in the manner in which the additional tag is added when different input tags are added to the same input content item. It is assumed that the user has added an input tag “information education” to the content item describing “Present state and issues of information education using tablet terminals” In this case, the tag “education” corresponding to the superordinate conception is added to the content item, and a tag “tablet application” corresponding to the subordinate conception is added thereto.

On the other hand, it is assumed that the user has added an input tag “tablet”. In this case, a tag “digital device” corresponding to the superordinate conception is added, and a tag “education utilization” corresponding to the subordinate conception, and being one of methods of utilization of the tablet terminal, is added.

It should be noted that the tag names “information education” and “tablet” mentioned herein are to be added by the user, and so the names to be specifically added are changeable depending on the utilization form of the user.

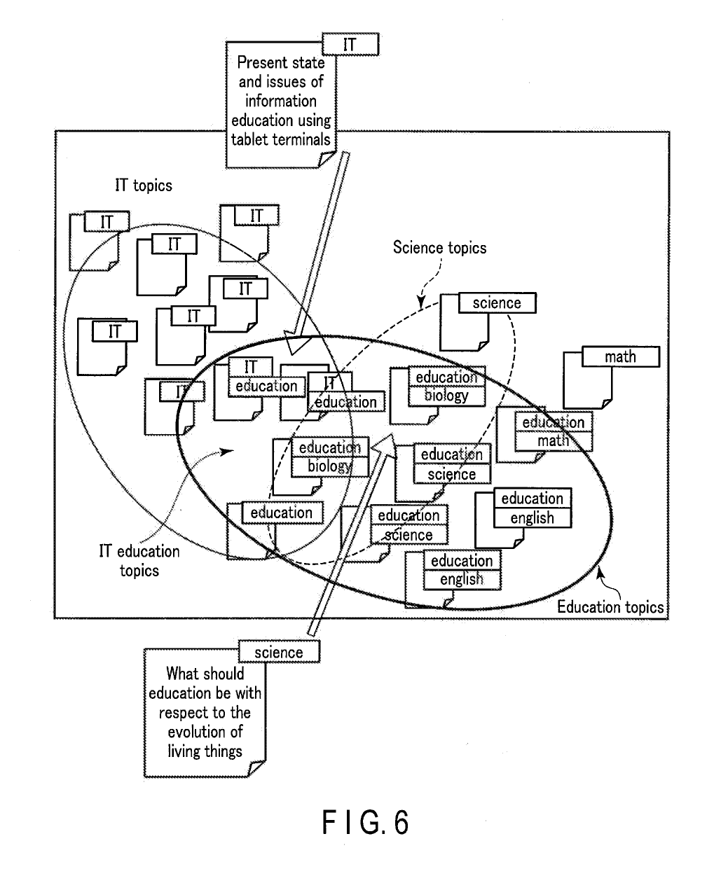

The case where the user newly stores the content item associated with Information Technology (IT), and the content item associated with education in the content storage unit 102 will be described below with reference to FIG. 6. FIG. 6 shows registered content items to which registered tags including the tags “IT”, “education”, “science”, and the like are added in an extracting manner. The arrangement shown in FIG. 6 is an expedient arrangement to express the closeness in topics between the registered content items.

A case is assumed where the user adds the tag “science” to the content item associated with “What should education be with respect to the evolution of living things”, and stores the content item. In the example shown in FIG. 6, the registered tag “education” is also added to numerous registered content items to which the registered tag “science” is added. Accordingly, the registered tag “education” is determined as the additional tag.

In the case where the number of registered content items to which registered tags “science” are added, i.e., the number of content items of the first content aggregate is equal to or greater than a threshold; “biology”, “math”, “English”, and the like are extracted as registered tags forming the sub-aggregates. A similarity between each of the sub-aggregates and input content item is calculated. As the basis of calculation, anything may be used if it is an indicator based on the feature forming the content item such as cosine similarity of a document vector, BM25, and the like. If it is assumed that a sub-aggregate corresponding to the tag “biology” among the above is closest to the input content item, the tag “biology” is determined as an additional tag.

Note that when the number of the content items of the first content aggregate is equal to or greater than the threshold, the additional tag may be selected from words (character strings) included in the input content item. The first content aggregates are classified into one or more clusters by clustering, a word representing a cluster including the input content item is extracted by using an indicator such as IDF or the like, and the extracted word is determined as an additional tag. As the clustering method, a generally used method such as the hierarchical clustering, k-means, etc. can be used. In this example, the words in the input content item such as “living things”, “evolution”, and the like can be determined as the additional tags.

Next, a case is assumed where the user adds a tag “IT” to the content item associated with “Present state and issue of information education using tablet terminals”, and stores the content item. When the number of registered content items to which tags “IT” are added is equal to or greater than the threshold, the registered tag “education” forming the sub-aggregate closest to the input content item, the word “information education”, etc. in the input content item are determined as the additional tags.

In the example of FIG. 6, although the content aggregate is illustrated on the basis of the case where “science” or “IT” is given as the input tag, when the user adds a different tag to the same content item, tags forming the inclusion relation can be different with respect to the same content aggregate.

It should be noted that when a registered tag having a name different from the input tag is added to the registered content item having details similar to the input content item, the additional tag determination unit 105 regards the registered tag as a synonym for the input tag. For example, “information technology” and “IT” are regarded as synonyms. Specifically, the additional tag determination unit 105 can determine this registered tag as an additional tag, or can unify the names of the registered tag and input tag into one of the names. In the case of the former, a registered tag having a name identical to the input tag can be added to the registered content item.

Next, a content search apparatus that retrieves the content item desired by the user from an aggregate of content items to which tags are added according to the above-mentioned system will be described below.

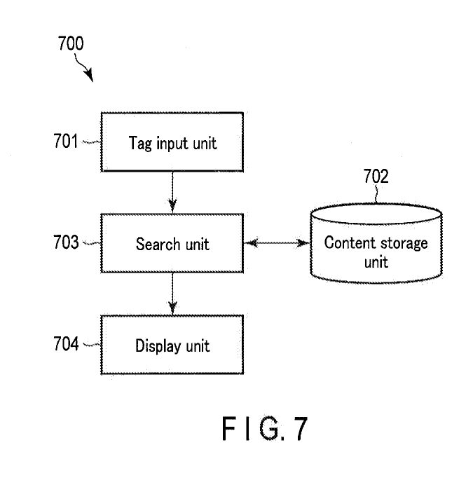

FIG. 7 schematically shows a content search apparatus 700 according to an embodiment. As shown in FIG. 7, the content search apparatus 700 includes a tag input unit 701, content storage unit 702, search unit 703, and display unit 704. The tag input unit 701, content storage unit 702, and search unit 703 carry out operations identical to the operations of the tag input unit 101, content storage unit 102, and search unit 103, respectively. Accordingly, detailed descriptions of the tag input unit 701, content storage unit 702, and search unit 703 are omitted.

The display unit 704 displays thereon various screens such as an input screen of a search query, screen of a search result, and the like. For example, as shown in FIG. 2A, the display unit 704 displays a screen presenting a plurality of tags serving as search query candidates to the user. The tag input unit 701 accepts a tag selected by the user from among the presented tags. The search unit 703 searches the registered content items to each of which a registered tag coincident with the selected tag is added from the content storage unit 702. The display unit 704 displays a screen presenting a list of registered content items obtained as a result of the search.

As described above, through the tag input to be carried out by the user, the tag adding apparatus 100 according to this embodiment has flexibility from the viewpoint of arrangement. Furthermore, the tag adding apparatus 100 complements a tag in a hierarchical relationship in consideration of search refinement. Thereby, both of ease of classification, and a reduction in search effort are realized.

### MODIFICATION EXAMPLE

The tag adding apparatus 100 according to this embodiment adds an additional tag at a timing at which the user adds the input tag. In this case, the additional tag may differ between the case where there are few registered content items and registered tags, and the case where there are numerous registered content items and registered tags, even when the same input tag is added to the same input content item. Especially in the former case, there is a possibility of the added additional tag being insufficient.

In the modification example of this embodiment, the processing of adding an additional tag to the input content item is executed at predetermined timing or at a timing at which the user carries out an explicit operation. The predetermined timing is, for example, a point in time for carrying out a periodic review. The timing at which the user carries out an explicit operation is, for example, a point in time at which the user executes a search operation of the content item. In this case, the adding of the additional tags is executed in the range of the entire registered content items or within a limited range of, for example, registered content items to which registered tags coincident with the tag designated as the retrieval query are added. A criterion for determination as to whether or not additional-tag adding processing should be executed again can be based on, for example, the time elapsed from execution of the last tag adding processing. Specifically, additional-tag adding processing may be executed again for registered content items for which a predetermined period of time has elapsed since the last tag adding processing has been executed.

Regarding the case where a periodic review is also carried out, the selection criterion of the content item can be identical to the above. Apart from the above, it is also conceivable that the additional tag may be reviewed at a timing in which the content aggregate itself significantly changes. For example, a case where a television program is treated as a content item is assumed. In this case, as the tag, there are tags personally added by the user, and in addition to information described in the metadata, for example, a program guide, such as a name of a leading actor/actress, genre, broadcasting station, etc can be a tag. Regarding programs personally recorded and managed by the user, it is assumed that the user inputs or selects a tag, and an additional tag is correspondingly added. Other programs also exist which are not recorded, but are listed in the program guide. In such a case, new programs are automatically registered every day, and old programs are deleted. Also, when there is a large change in the content group of the management object such as rearrangement of the program configuration, and new construction of a broadcasting station, it is conceivable that the details of programs to be managed are significantly changed at one time. Concurrent with the change, the management details of tags are also influenced, and thus it is necessary to conduct a complete review of the configuration of tags.

In the tag adding apparatus according to the embodiment, although implementation in a portable hardware device is assumed, part of the functions thereof may be executed on an external server connected thereto through a network. It is also possible to implement the tag adding apparatus in a general computer including a control device such as a CPU, storage device such as a ROM, RAM, external storage device such as an HDD, display device such a liquid crystal display device, and input device such as a keyboard and mouse.

Instructions shown in the processing procedure shown in the above embodiment can be executed on the basis of a software program. A general-purpose computer system stores therein this program in advance, and reads this program, whereby it is also possible to obtain an advantage identical to the advantage obtained by the above-mentioned tag adding apparatus. Instructions described in the above-mentioned embodiment are recorded on a magnetic disk (flexible disk, hard disk, etc.), optical disk (CD-ROM, CD-R, CD-RW, DVD-ROM, DVD±R, DVD±RW, Blu-ray (registered trade mark) Disc, etc.), and semiconductor memory or other recording media similar to this as a program which can be executed by a computer. If these recording media are recording media which can be read by a computer or an embedded system, their storage form may have any configuration. The computer can realize an operation identical to the above-mentioned tag adding apparatus by reading the program from this recording medium, and causing the CPU to execute the instructions described in the program on the basis of the program. Of course, when acquiring the program or when reading the program, the computer may acquire or read the program through a network. The middleware (MW) or the like such as an operating system (OS), database-management software, network, etc. operating on the computer on the basis of instructions of the program installed from the recording medium onto the computer or the embedded system may execute part of each of the processing items for realizing the embodiment.

Furthermore, the recording medium in the embodiment is not limited to a medium independent of the computer or the embedded system, and a recording medium storing or temporarily storing therein a downloaded program transmitted through a LAN, the Internet, or the like is also included in the scope of the recording medium in the embodiment.

Also, the recording medium is not limited to one recording medium and, when the processing of the embodiment is executed on the basis of a plurality of media, the media are included in the scope of the recording medium in the embodiment, and the configuration of each medium may be any type of configuration.

It should be noted that the computer or the embedded system in the embodiment is designed to execute each processing item in the embodiment on the basis of the program stored in the recording medium, and may have one of the configurations of a device formed by one of a personal computer and microcomputer, and a system in which a plurality of devices are network-connected.

In addition, the computer in the embodiment is not limited to a personal computer, and includes an arithmetic processing unit, microcomputer, etc. included in an information processing apparatus, and apparatuses and devices capable of realizing the functions in the embodiment by means of a program are generically called a computer in the embodiment.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A tag adding apparatus comprising:
an input unit which inputs an input tag added to an input content item;
a storage unit which stores registered content items in association with registered tags added to the registered content items;
a search unit which retrieve a first content aggregate and a second content aggregate from the storage unit, the first content aggregate being an aggregate of registered content items to which registered tags matching the input tag are added, the second content aggregate being an aggregate of registered content items to which registered tags matching an additional tag candidate are added;
an analyzer which analyzes the number of registered content items of the first content aggregate, and to analyze an inclusion relationship between the first content aggregate and the second content aggregate;
a determination unit which determines an additional tag to be additionally added to the input content item based on a result of analysis by the analyzer; and
a registration unit which registers the input content item in the storage unit in association with the input tag and the additional tag.

2. The apparatus according to claim 1, wherein when the number of registered content items of the first content aggregate is equal to or greater than a threshold, the determination unit determines, as the additional tag, a registered tag added to a registered content item in the first content aggregate and contributory to search refinement of the input content item in the first content aggregate, or a word in the input content item and contributory to search refinement of the input content item in the first content aggregate.

3. The apparatus according to claim 1, wherein processing of adding the additional tag to the input content item is executed at a predetermined timing or at a timing at which the user carries out an explicit operation.

4. The apparatus according to claim 1, wherein the second content aggregate is an aggregate of registered content items to which registered tags matching a registered tag added to a registered content item in the first content aggregate are added.

5. The apparatus according to claim 1, wherein when the second content aggregate includes the first content aggregate, the determination unit determines the additional tag candidate as the additional tag.

6. The apparatus according to claim 5, wherein that the second content aggregate includes the first content aggregate indicates that a ratio of registered content items included in both the first content aggregate and the second content aggregate, to all of the registered content items included in the first content aggregate is equal to greater or than a threshold.

7. The apparatus according to claim 1, wherein when a registered tag different from the input tag is added to a registered content item stored in the storage unit, and details of which are similar to the input content item, the determination unit regards the registered tag as a synonym for the input tag.

8. The apparatus according to claim 1, wherein the analyzer creates sub-aggregates from the first content aggregate, and sets the registered tags forming the sub-aggregates to additional tag candidates.

9. A tag adding method, comprising:
inputting an input tag added to an input content item;
retrieving a first content aggregate and a second content aggregate from a storage unit in which registered content items are stored in association with registered tags added to the registered content items, the first content aggregate being an aggregate of registered content items to which registered tags matching the input tag are added, the second content aggregate being an aggregate of registered content items to which registered tags matching an additional tag candidate are added;
analyzing the number of registered content items of the first content aggregate, and to analyze an inclusion relationship between the first content aggregate and the second content aggregate;
determining an additional tag to be additionally added to the input content item based on a result of analysis; and
registering the input content item in the storage unit in association with the input tag and the additional tag.

10. The method according to claim 9, wherein the determining the additional tag comprises determining, as the additional tag, a registered tag added to a registered content item in the first content aggregate and contributory to search refinement of the input content item in the first content aggregate, or a word in the input content item and contributory to search refinement of the input content item in the first content aggregate when the number of the content items of the first content aggregate is equal to or greater than a threshold.

11. The method according to claim 9, wherein processing of adding the additional tag to the input content item is executed at a predetermined timing or at a timing at which the user carries out an explicit operation.

12. The method according to claim 9, wherein the second content aggregate is an aggregate of registered content items to which registered tags matching a registered tag added to a registered content item in the first content aggregate are added.

13. The method according to claim 9, wherein the determining the additional tag comprises determining the additional tag candidate as the additional tag when the second content aggregate includes the first content aggregate.

14. The method according to claim 5, wherein that the second content aggregate includes the first content aggregate indicates that a ratio of registered content items included in both the first content aggregate and the second content aggregate, to all of the registered content items included in the first content aggregate is equal to greater or than a threshold.

15. The method according to claim 9, wherein when a registered tag different from the input tag is added to a registered content item stored in the storage unit, and details of which are similar to the input content item, the registered tag is regarded as a synonym for the input tag.

16. The method according to claim 9, further comprising creating sub-aggregates from the first content aggregate, and setting the registered tags forming the sub-aggregates to additional tag candidates.

17. A non-transitory computer readable medium including computer executable instructions, wherein the instructions, when executed by a processor, cause the processor to perform a method comprising:
inputting an input tag added to an input content item;
retrieving a first content aggregate and a second content aggregate from a storage unit in which registered content items are stored in association with registered tags added to the registered content items, the first content aggregate being an aggregate of registered content items to which registered tags matching the input tag are added, the second content aggregate being an aggregate of registered content items to which registered tags matching an additional tag candidate are added;
analyzing the number of registered content items of the first content aggregate, and to analyze an inclusion relationship between the first content aggregate and the second content aggregate;
determining an additional tag to be additionally added to the input content item based on a result of analysis; and
registering the input content item in the storage unit in association with the input tag and the additional tag.
